(19) United States
(12) Patent Application Publication
(10) Pub. No.: US 2026/0099133 A1
(43) Pub. Date: Apr. 9, 2026

(54) TUBULAR PASSAGEWAY CENTRIFUGAL IMPELLERS AND METHODS FOR MAKING SAME

(71) Applicant: Crane Pumps & Systems PFT Corp., Piqua, OH (US)

(72) Inventor: Ia Kidd, Dayton, OH (US)

(21) Appl. No.: 19/325,267

(22) Filed: Sep. 10, 2025

Related U.S. Application Data
(60) Provisional application No. 63/703,848, filed on Oct. 4, 2024.

(51) Int. Cl. G05B 19/4093

(52) U.S. Cl. CPC G05B 19/40937; G05B 2219/45225

(57) ABSTRACT

An internal flow path, throat way, and inlet pathway define a tubular centrifugal impeller. A radius and separation of an upper shroud and lower shroud, and a radius of an inlet section determine a shape of a baseline impeller that comprises a sealed shroud having the radius and including the upper shroud and the lower shroud, which are separated by the separation. The upper and lower shroud are connected by a virtual vane following a first vane path. An internal flow path comprises a spline centerline connecting a series of section areas disposed along the first vane path, with each section area disposed along the spline centerline being connected along the spline centerline to define an internal flow path. The internal flow path is extended to meet the inlet section to define the throat way, together with an inlet pathway extending from the inlet section.

### CROSS REFERENCE TO RELATED APPLICATIONS

This application claims benefit of U.S. Provisional Application No. 63/703,848, filed October 4, 2024, entitled TUBULAR PASSAGEWAY CENTRIFUGAL IMPELLERS AND METHODS FOR MAKING SAME, the specifications of which are incorporated by reference herein in their entirety.

### TECHNICAL FIELD

The present disclosure relates to pump design, in particular pumps suitable for use with heterogeneous media comprising solids and liquids, including, without limitation, sewage. More specifically, the present disclosure relates to centrifugal impellers with tubular passageways and methods for making and optimizing same.

### BACKGROUND

Heterogenous media, such as sewage, in which solids and in particular stringy solids, are mixed in with liquids present unique challenges in the field of pump design. While centrifugal pumps comprising a rotating impeller and raised impeller vanes can pump sewage and other media containing stringy solids, such designs force users to choose between one or more undesirable design tradeoffs. This is due, in part, to the fact that such impellers span a clear space between the impeller upper shroud and the impeller lower shroud, creating catch points between the upper and lower shrouds in which solids can catch and become lodged on the leading edge of the vanes. Such lodged media can become increasingly stacked and require an increase in the drive power needed to maintain a given flow rate. Increasing the drive power imposes inefficiencies and increased wear on the pump and vane components. Over time this build up will eventually fill the space between the upper and lower shrouds, blocking flow through this space.

Tubular impellers, which comprise an enclosed flow passageway along a spiral-shaped centerline ameliorate many of the problems associated with raised-vane centrifugal impellers by providing a smooth flow passageway devoid of the aforementioned pinch points. However, because tubular impellers do not have vanes, they are difficult to design and optimize using conventional impeller tools, which have been developed on the assumption of vaned impellers. Put differently, existing design tools predict the flow properties of the impeller based on the shape of the vanes of the impeller. While this approach makes perfect sense in the context of vaned impellers, it becomes unworkable in the context of vane-less, or tubular impellers.

Thus, developing impellers which can handle the challenges of mixed pumping media without requiring the driving force applied to the impeller, as well as refining the tools for designing tubular impellers remain a source of technical challenges and opportunities for improvement in the art.

### SUMMARY

The present disclosure illustrates embodiments of centrifugal impellers with tubular passageways and methods for making and optimizing same.

In some embodiments, a non-transitory computer-readable medium includes instructions, which, when executed by a processor, cause an apparatus to obtain first information specifying the radius and separation of an upper shroud and lower shroud, and a radius of an inlet section; obtain a first vane path; based on the first information, determine a shape of a baseline impeller, wherein the baseline impeller comprises a sealed shroud having the obtained radius and comprising the upper shroud and the lower shroud, wherein the upper shroud and lower shroud are separated by the obtained separation, and wherein the upper and lower shroud are connected by a virtual vane following the first vane path. When executed by the processor, the instructions can further cause the apparatus to define an internal flow path, wherein the internal flow line comprises a spline centerline connecting a series of section areas disposed along the first vane path; for each section area disposed along the spline centerline, connect the section areas along the spline centerline to define the internal flow path; extend the internal flow path to meet the inlet section to define a throat way; and define an inlet pathway extending from the inlet section.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate views of a tubular impeller for a centrifugal pump according to various embodiments of this disclosure;

FIGS. 2A-2H illustrate aspects of a method for determining an internal flow path, throat way, and inlet section of a tubular impeller according to various embodiments of this disclosure;

FIG. 3 illustrates an example of a “Delta” cross-section of an internal flow path according to various embodiments of this disclosure;

FIG. 4 illustrates operations of an example method for determining the internal flow path, throat way, and inlet section according to embodiments of this disclosure; and

FIG. 5 illustrates an example electronic device and network configuration that may be employed for determining an internal flow path, throat way, and inlet section of a tubular impeller according to various embodiments of this disclosure.

### DETAILED DESCRIPTION

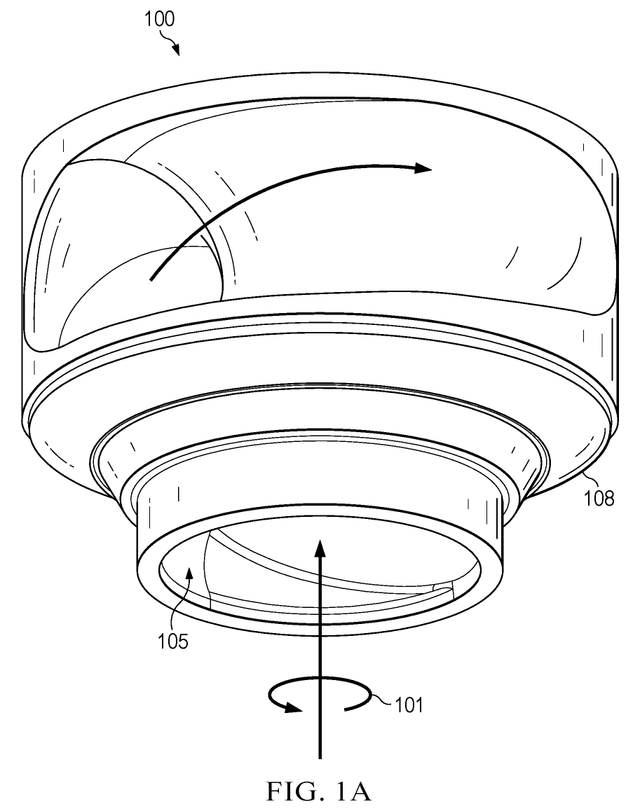

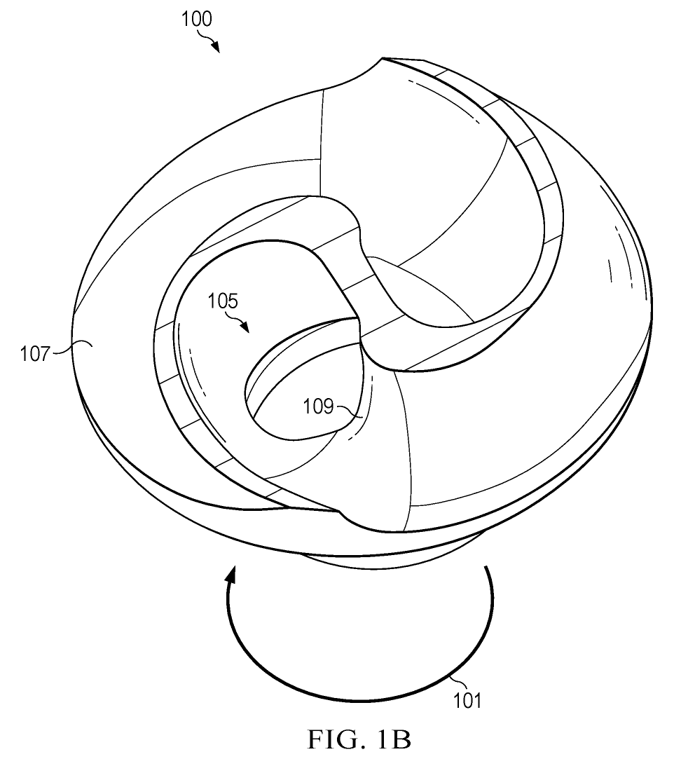

FIGS. 1A through 5, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged security document.

Although the present disclosure has been described with various embodiments, various changes and modifications may be suggested to one skilled in the art. It is intended that the present disclosure encompasses such changes and modifications as falling within the scope of the claims.

Heterogeneous pumping media, in particular, heterogenous media with non-dissolving and/or stringy solids such as sewage, can clog the space between pump vanes protruding from an impeller shroud and pump casings and other internal of the pump. While trapped solids can be moved or ground down by increasing the power applied to the impeller, this is an inefficient and imperfect solution that decreases the efficiency of the system and increases the wear on impeller vanes, thereby degrading performance in the long-term. Additionally, increasing the drive power to an impeller does nothing to solve the problems of stronger, more durable solids in the pumping media not breaking down in response to the drive force, and instead jamming the pump.

Vane-less, tubular impellers present an attractive alternative to impellers with raised vanes by providing a smooth flow passage for waste, with no surfaces upon which non-dissolvable solids hang up. However, and as noted elsewhere in this disclosure, the existing impeller design tools are typically only configured for vaned impellers, where the flow properties within the pump are predominantly a function of vane shape and size. Such tools are inadequate for tubular impellers, which seek to replicate the natural fluid flow of pumping media through a pipe, albeit in the context of a rotating impeller. Natural fluid flows are premised on avoiding “dead zones” or regions of low pressure in which fluid stream lines become less direct. When working with heterogeneous pumping media, such “dead zones” or low-pressure regions can be particularly undesirable, in that solids can separate from the surrounding fluid, leading to unpredictable accumulation or ejection from the passageway of a tubular impeller.

FIGS. 1A and 1B provide views of a vane-less tubular impeller 100 according to this disclosure. For consistency and convenience of cross-reference, elements common to more than one of FIGS. 1A and 1B are numbered similarly.

Referring to the illustrative example of FIGS. 1A and 1B, a tubular impeller 100 for use in a centrifugal pump is shown in the figures. Tubular impeller 100 is suitable for use in a variety of centrifugal pumps, including, without limitation, diffusor pumps and volute pump designs. Tubular impeller 100 operates by being submerged in a volume of a pumping medium (for example, a liquid, or a liquid/solid mix, such as sewage) and rotating in preferred direction of direction 101. The rotation of tubular impeller 100 within the pumping medium creates a persistent pressure differential across surfaces of the tubular impeller 100, causing pumping medium to be sucked into inlet section 105, enter internal flow path 107 via throat way 109 connecting inlet section 105 to internal flow path 107.

Provided the profile of the internal flow path 107 does not contain any “dead spots” or significant discontinuities in the local size or shape of the flow path for the pumping medium through the impeller, tubular impeller 100 provides a smooth path along which the pumping medium can travel. However, ensuring a smooth path connecting inlet section 105, throat way 109, and internal flow path 107, and spiraling up and outward while at the same time ensuring the path is free of significant discontinuities in the trend of the flow path size, presents significant design challenges for which the existing design tools are inadequate. To solve this and create a predictable design environment for tubular impellers, embodiments according to the present disclosure use a notional closed, vaned impeller design as a design baseline for a tubular, vane-less impeller. This improbable and non-intuitive approach provides an efficient and structured way of realizing tubular impeller designs which can then be converted into G-code or other machine-readable instructions for manufacture by computer numerical control (CNC) milling machines or an additive manufacturing apparatus (for example, metallic three dimensional (3-D) printers).

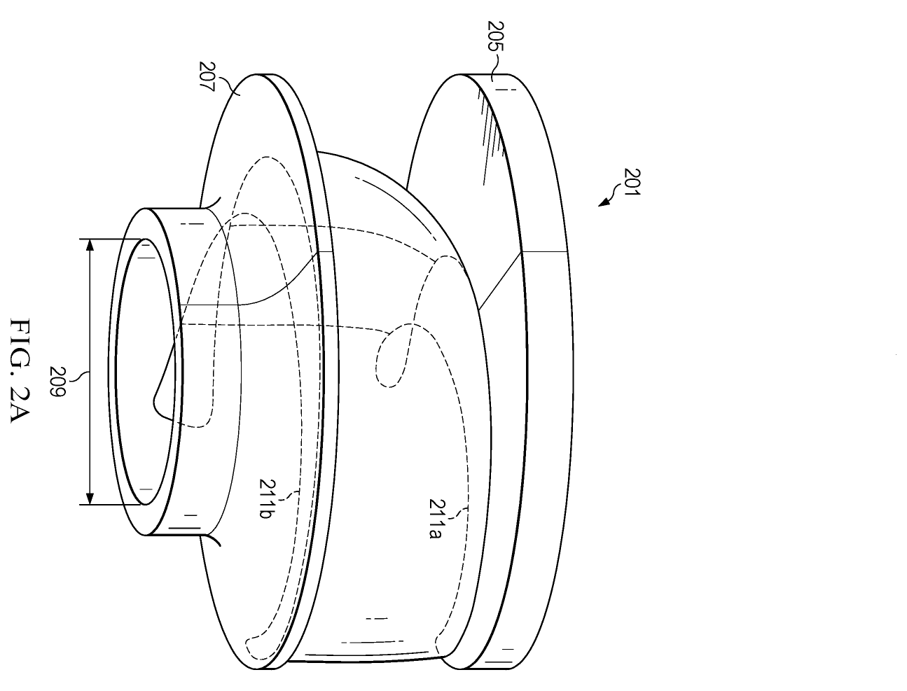

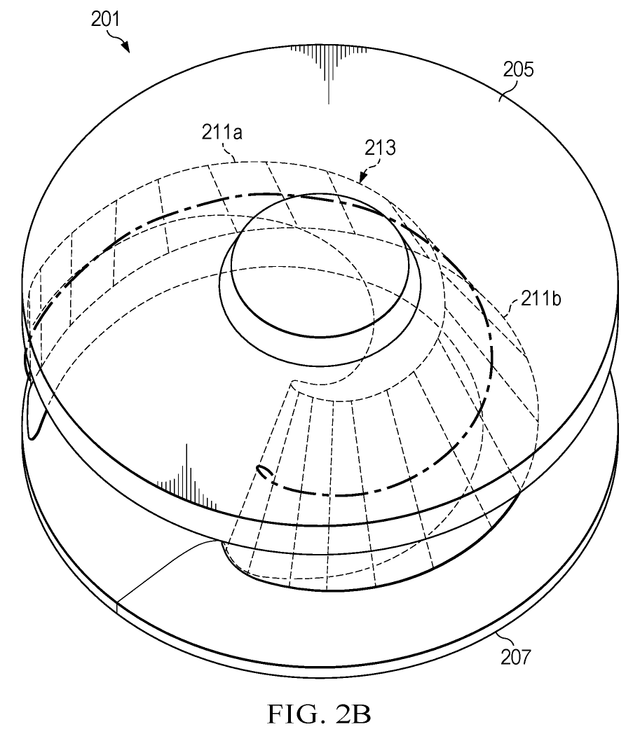

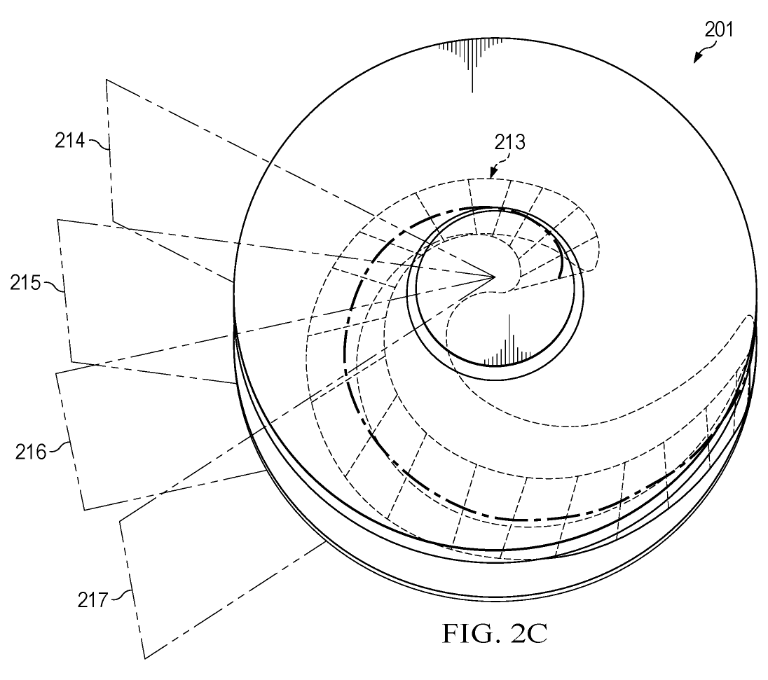

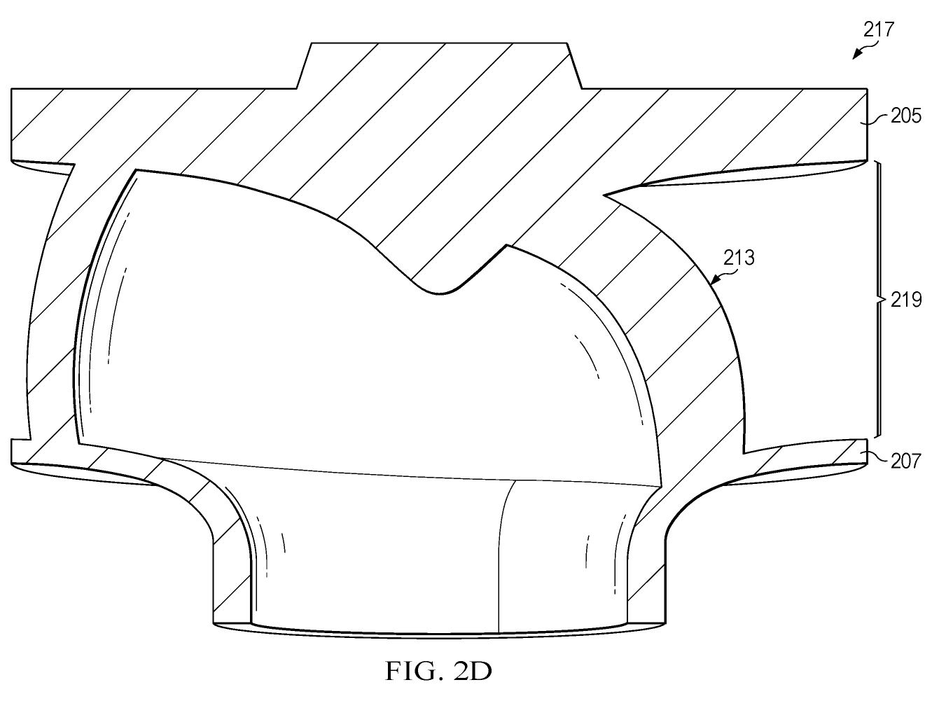

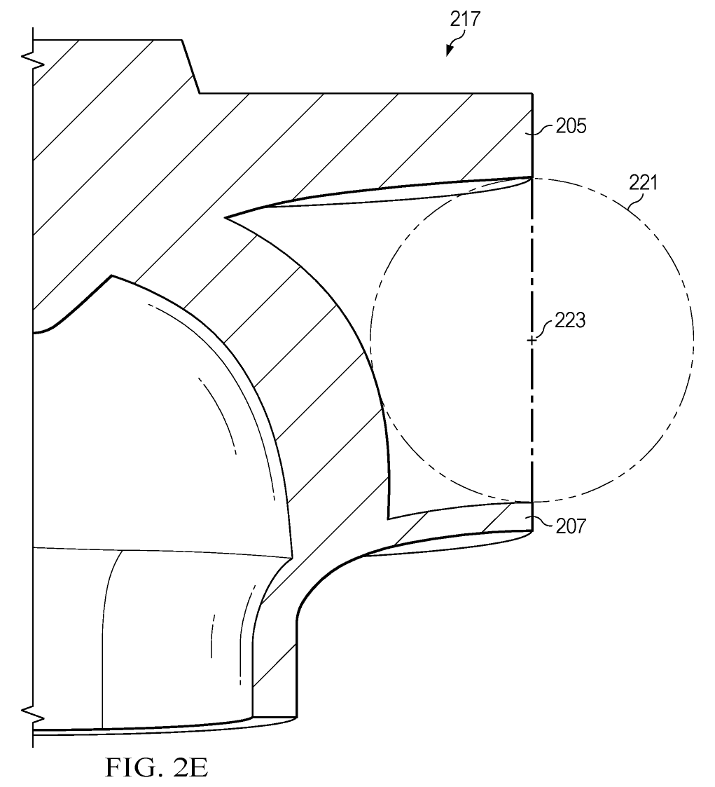

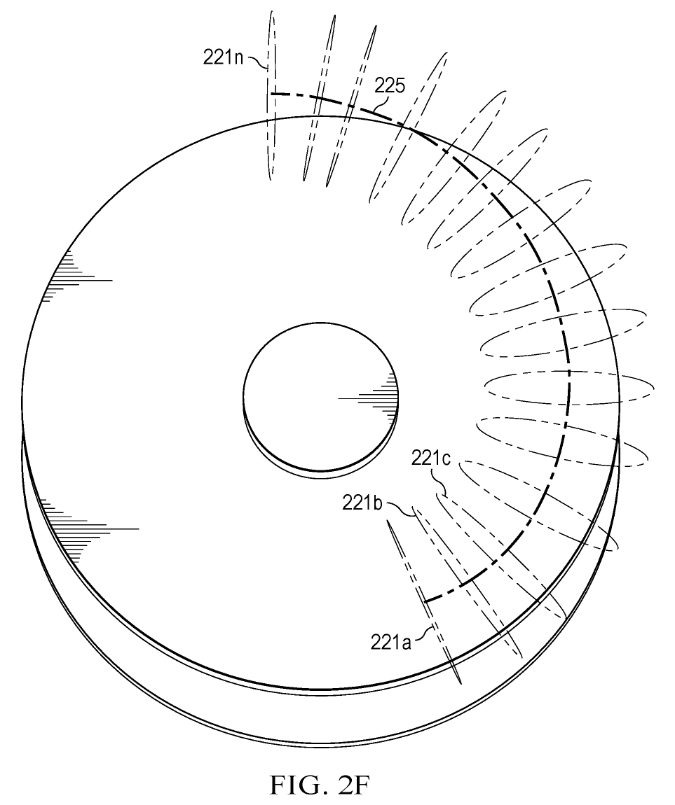

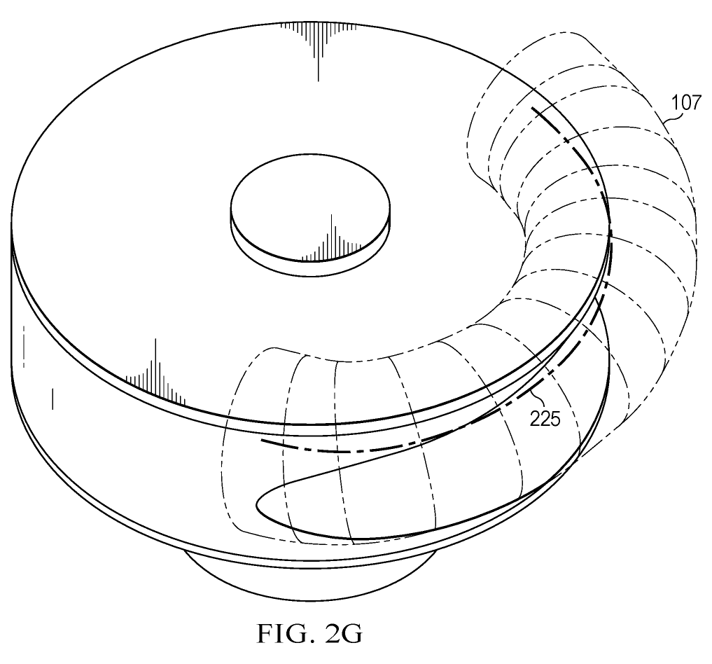

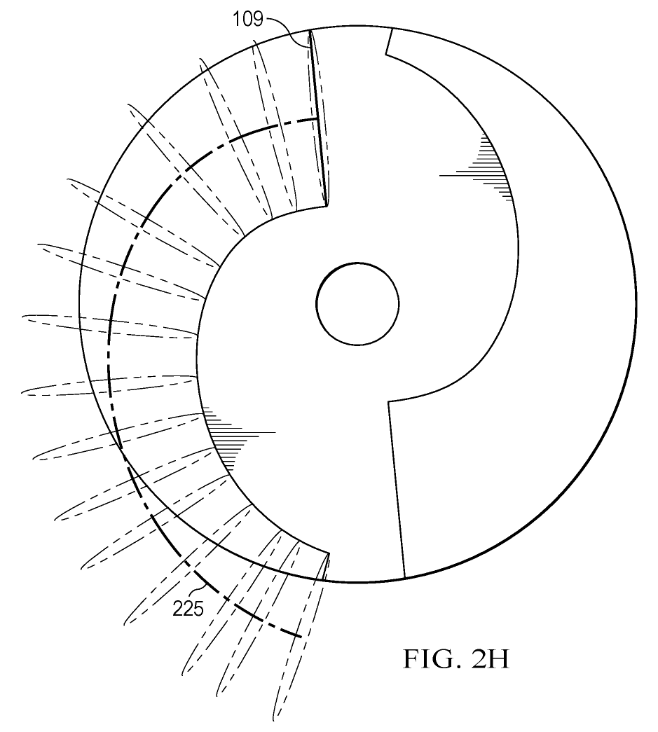

FIGS. 2A through 2H illustrate operations of a method for designing a vane-less tubular centrifugal impeller according to the present disclosure. For consistency and convenience of cross-reference, elements common to more than one of FIGS. 2A-2H are numbered similarly. The operations described with reference to FIGS. 2A-2H can be performed as operations of a computer program product, which is embodied as executable instructions on a non-transitory medium.

Referring to the illustrative example of FIGS. 2A and 2B, methods according to the present disclosure begin by defining the shape of a baseline, vaned impeller 201 whose dimensions define certain major parameters of the final, vane-less tubular impeller 100. Specifically, baseline impeller 201 is a closed centrifugal impeller comprising an upper shroud 205 and a lower shroud 207. Further, baseline impeller 201 has an inlet portion of diameter 209. Upon the framework of baseline impeller 201, a virtual vane 213 (shown in FIG. 2B as superimposed on the upper shroud 205 and the lower shroud 207) following a virtual vane path is defined. Virtual vane 213 follows the curve of a physical vane of a vaned impeller, with a curvature that is increasingly perpendicular to the radius of baseline impeller 201 at points approaching the perimeter of baseline impeller 201. The virtual vane 213 contacts upper shroud 205 along a first vane path 211a, and contacts lower shroud 207 along second vane path 211b. Skilled artisans will appreciate that, where first vane path 211a differs from second vane path 211b, the virtual vane 213 will be angled, and not necessarily perpendicular to either of upper shroud 205 or lower shroud 207. In simpler embodiments, wherein the virtual vane is perpendicular to both upper shroud 205 and lower shroud 207, there is no difference between first vane path 211a and second vane path 211b, and accordingly, only one vane path is needed to define virtual vane 213. Additionally, in some embodiments, virtual vane 213 can have a curved profile, wherein the local curvature is defined based on a curve fit to local values of three or more vane paths.

Referring to the illustrative examples of FIGS. 2C through 2F, a plurality of cross sections along a spline centerline is determined, from which the internal flow path (for example, internal flow path 107 in FIGS. 1A and 1B) is determined.

Referring to the illustrative example of FIG. 2C, a plurality of cross-sections of baseline impeller 201 (including virtual vane 213) are obtained at regular intervals along either of first vane path 211a or second vane path 211b. As shown in FIG. 2C, the cross-sections are obtained in planes (for example, planes 214, 215, 216, and 217 in FIG. 2C) which are perpendicular to virtual vane 213. An example cross-section for plane 217 is shown in FIG. 2D. For each of the cross-sections, a section area defining a local profile of internal flow path 107 is determined within the plane of the cross-section. According to some embodiments, the section areas are fitted in a space 219 such that the section areas make tangential contact with upper shroud 205 and lower shroud 207. In some embodiments, the section areas are fitted to make tangential contact with, or otherwise satisfy a spatial criteria based on the local location of virtual vane 213.

Referring to the explanatory example of FIG. 2E, an example section area 221 is shown as being fitted to make tangential contact with upper shroud 205 and lower shroud 207. While FIG. 2E shows section area 221 as being circular in shape, embodiments according to this disclosure are not so limited, and a variety of section area cross-sectional profiles are possible and contemplated. For applications in which tubular impeller 100 is expected to work with pumping media containing solids, circular or oval cross-sectional profiles can be desirable, as those shapes define a flow path having a single vortex (like a round pipe) and present less risk of solid separation. However, for more tractable pumping media, cross-sectional profiles composed from multiple circles or ovals (and thus having multiple vortices) are possible and can improve throughput. Section area 221 has a center point 223. Center point 223 can be the centroid of the shape defining section area 221.

Referring to the illustrative example of FIG. 2F, the process of determining section areas is repeated across all of the cross-sections within the planes shown in FIG. 2C, until a full set of section areas (for example, section areas 221a, 221b, 221c, …, 221n) is obtained. At this point, a spline centerline 225 connecting the center points (for example, center point 223) of each of the section areas is drawn. At this point, the size or position of each of the determined section areas may be tuned to optimize the smoothness of the passage of fluid medium through tubular impeller 100. For example, the shapes of one or more cross sections may be adjusted to ensure that spline centerline 225 defines a smooth curve. Additionally, the areas of each of the determined section areas may be calculated to see if there are any outliers (for example, section areas that are considerably larger or smaller than neighboring section areas) which could contribute to bulges or choke points in internal flow path 107.

Once section areas 221a-221n have been adjusted to satisfy one or more of smoothness constraints for spline centerline 225 or to eliminate excessive local variations in cross-sectional areas, the section areas are connected along spline centerline 225 to define the internal flow path 107, as shown in FIG. 2G.

Referring to the illustrative example of FIG. 2H, with the contours and shape of internal flow path 107 set, the process of taking additional cross sections is repeated in the opposite direction, along a curve connecting spline centerline 225 to a center point of inlet section 105, to define throat way 109 and inlet section 105. Having determined the fluid flow path for vane-less tubular impeller 100, structural space, such as sidewalls filling the gaps between the upper and lower shrouds of the baseline impeller can be defined, and additional, reinforcing structures, such as a suction bell 108 defining the lower portion of tubular impeller 100 can be added. Further, the defined space can be exported as G-code or other data form usable by a CNC milling machine or additive manufacturing apparatus to build designed tubular impeller 100.

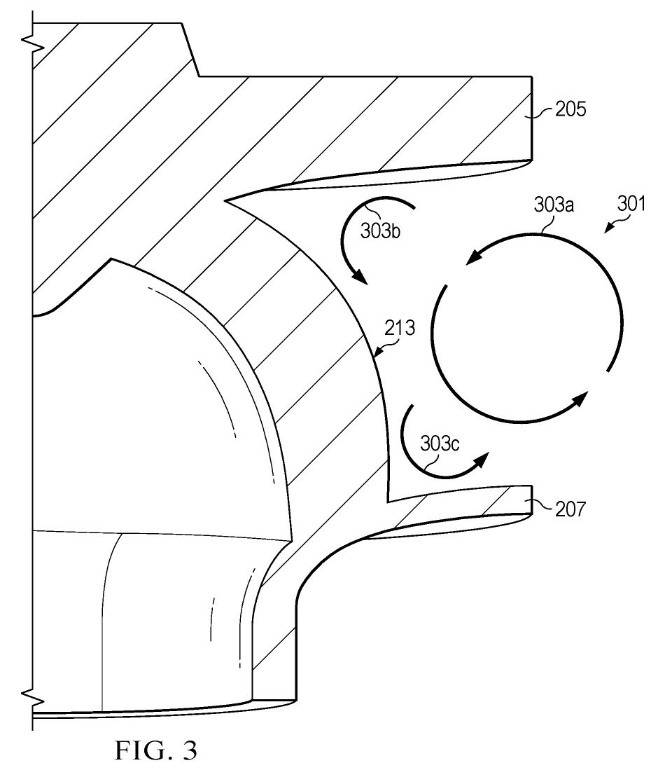

FIG. 3 illustrates an example of a “Delta” section area according to various embodiments of this disclosure. Referring to the illustrative example of FIG. 3, a cross section (for example, cross-section 217) of baseline impeller 201, taken in a plane perpendicular to a virtual vane is shown in the figure. In contrast to the example shown in FIG. 2E, instead of a circular section area (for example, section area 221) being fit to the space between upper shroud 205 and lower shroud 207, a “Delta” section area 301 is fitted in the space between the shrouds. As shown in the figure, “Delta” section area 301 comprises a superposition of three circular or ovoid shapes, which are designed to structure the flow of pumping medium into three vortices, comprising a main vortex 303a and two secondary vortices 303b and 303c. In this way, “Delta” section area 301 is able to create efficient flows of pumping medium in the pockets between the upper and lower shrouds and virtual vane 213. For certain applications, this produces an increase in the efficiency and throughput of tubular impeller 100.

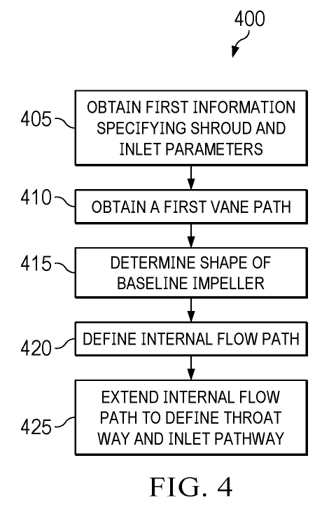

FIG. 4 describes operations of an example method 400 for determining the internal flow path of vane-less centrifugal impeller (for example, tubular impeller 100 in FIGS. 1A and 1B).

At operation 405, first information specifying spatial parameters of an impeller is obtained. The first information can include the radii of upper and lower shrouds of an impeller, the separation between the shrouds, and the diameter or inlet of an inlet section of the impeller. As discussed elsewhere in this disclosure, the spatial parameters obtained at operation 405 are used to determine the shape of a baseline impeller, from which a tubular flow path can be determined.

At operation 410, at least one (and in some embodiments) vane path (for example, first and second vane paths 211a and 211b are obtained. The obtained vane paths define a path of contact on a shroud made by a physical vane. Where the vane is angled or has a curve, more than one vane path can be obtained at operation 410.

At operation 415, the shape of a baseline impeller, including a virtual vane (for example, virtual vane 413) bridging a gap between the upper and lower shrouds is determined.

At operation 420, an internal flow path is determined. As described with reference to FIGS. 2G, the internal flow path can be determined by fitting section areas to cross-sections of the baseline impeller, and then tuning the areas or positions of the fitted section areas to satisfy one or more fluid dynamic criteria (for example, smoothness of a spline centerline, or minimizing local variations in area of cross section). Once a set of suitable section areas has been determined, the sections areas can be connected (for example, by calculating loft curves) to define an internal flow path for the impeller.

At operation 425, having determined the form of the internal flow path, the internal flow path is extended towards an inlet section to define a throat way and inlet pathway.

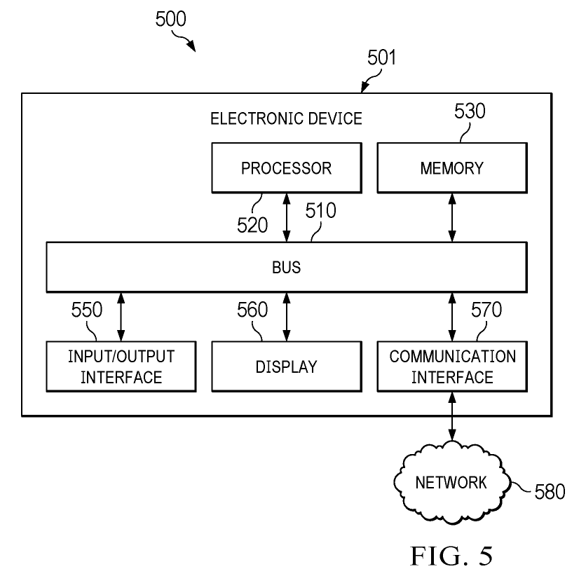

FIG. 5 illustrates an example electronic device and network configuration that may be employed for determining an internal flow path, throat way, and inlet section of a tubular impeller according to various embodiments of this disclosure. The embodiment shown in FIG. 5 is for illustration only. Other embodiments could be used without departing from the scope of this disclosure.

According to embodiments of this disclosure, an electronic device 501 is included in the network configuration 500. The electronic device 501 may be a computer (e.g., desktop, laptop, tablet, or similar device) on which design software such as computer-aided design (CAD) software executes. All or any part of the design software may comprise artificial intelligence (AI) or machine learning (ML) model(s). The electronic device 501 can include at least one of a bus 510, a processor 520, a memory 530, an input/output (I/O) interface 550, a display 560, or a communication interface 570. In some embodiments, the electronic device 501 may exclude at least one of these components or may add at least one other component. The bus 510 includes a circuit for connecting the components 520-570 with one another and for transferring communications (such as control messages and/or data) between the components.

The processor 520 includes one or more processing devices, such as one or more microprocessors, microcontrollers, digital signal processors (DSPs), application specific integrated circuits (ASICs), or field programmable gate arrays (FPGAs). In some embodiments, the processor 520 includes one or more of a central processing unit (CPU), an application processor (AP), or a graphics processor unit (GPU). The processor 520 is able to perform control on at least one of the other components of the electronic device 501 and/or perform an operation or data processing relating to design or other functions. As described in more detail herein, the processor 520 may perform various operations related to determining an internal flow path, throat way, and inlet section of a tubular impeller.

The memory 530 can include a volatile and/or non-volatile memory. For example, the memory 530 can store commands or data related to at least one other component of the electronic device 501. According to embodiments of this disclosure, the memory 530 can store software and/or a program. The program includes, for example, a kernel, middleware, an application programming interface (API), and/or an application program (or “application”). At least a portion of the kernel, middleware, or API may be denoted an operating system (OS).

The I/O interface 550 serves as an interface that can, for example, transfer commands or data input from a user or other external devices to other component(s) of the electronic device 501. The I/O interface 550 can also output commands or data received from other component(s) of the electronic device 501 to the user or the other external device.

The display 560 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 560 can also be a depth-aware display, such as a multi-focal display. The display 560 is able to display, for example, various contents (such as text, images, videos, icons, or symbols) to the user. The display 560 can include a touchscreen and may receive, for example, a touch, gesture, proximity, or hovering input using an electronic pen or a body portion of the user.

The communication interface 570, for example, is able to set up communication between the electronic device 501 and an external system (such as a server). For example, the communication interface 570 can be connected with a network 580 through wireless or wired communication to communicate with the external system. The communication interface 570 can include a wired or wireless transceiver or any other component for transmitting and receiving signals.

Although FIG. 5 illustrates one example of electronic device 501 within a network configuration 500 including the electronic device 501, various changes may be made to FIG. 1. For example, the network configuration 500 could include any number of each component in any suitable arrangement. In general, computing and communication systems come in a wide variety of configurations, and FIG. 5 does not limit the scope of this disclosure to any particular configuration. Also, while FIG. 5 illustrates one operational environment in which various features disclosed in this patent document can be used, these features could be used in any other suitable system.

A non-transitory computer-readable medium according to various embodiments of this disclosure contains instructions which, when executed by at least one processing device of an electronic device, cause the at least one processing device to obtain first information specifying a radius and separation of an upper shroud and lower shroud, and a radius of an inlet section. The instructions when executed cause the at least one processing device to obtain a first vane path. The instructions when executed cause the at least one processing device to determine, based on the first information, a shape of a baseline impeller, where the baseline impeller comprises a sealed shroud having the obtained radius and comprising the upper shroud and the lower shroud, wherein the upper shroud and lower shroud are separated by the obtained separation, and where the upper and lower shroud are connected by a virtual vane following the first vane path. The instructions when executed cause the at least one processing device to define an internal flow path, wherein the internal flow path comprises a spline centerline connecting a series of section areas disposed along the first vane path. The instructions when executed cause the at least one processing device to connect the section areas along the spline centerline to define the internal flow path, for each section area disposed along the spline centerline. The instructions when executed cause the at least one processing device to extend the internal flow path to meet the inlet section to define a throat way. The instructions when executed cause the at least one processing device to define an inlet pathway extending from the inlet section.

Non-transitory computer-readable media according to various embodiments of this disclosure may include instructions, which, when executed by the processing device, cause the processing device to generate instructions for at least one of an additive manufacturing machine or CNC milling machine to make an impeller comprising the internal flow path, throat way and inlet pathway.

Non-transitory computer-readable media according to various embodiments of this disclosure may include instructions, which, when executed by the processing device, may cause the processing device to configure an impeller that is a vane-less centrifugal impeller.

Non-transitory computer-readable media according to various embodiments of this disclosure may include instructions, which, when executed by the processing device, cause the processing device to define a second instance of the internal flow path, wherein the second instance of the internal flow path is angularly offset from another instance of the internal flow path, and define a second instance of the throat way, wherein the second instance of the throat way is angularly offset from another instance of the throat way.

Non-transitory computer-readable media according to various embodiments of this disclosure may include instructions which, when executed by the processing device, cause the processing device to, subsequent to determining the shape of the baseline impeller, dividing the virtual vane into a plurality of sections; determine, for each section of the plurality of sections, a cross-section of the impeller along a plane perpendicular to the virtual vane; select a cross-sectional profile; for each cross-section, fit an instance of the selected cross-sectional profile, wherein the cross-sectional profile makes tangential contact with the upper shroud and the lower shroud; and perform a lofting operation connecting the instances of the selected cross-sectional profile along the spline centerline to define the internal flow path.

Non-transitory computer-readable media according to various embodiments of this disclosure may include instructions such that the selected cross-sectional profile has a circular or ovoid shape defining a space for one vortex of flow.

Non-transitory computer-readable media according to various embodiments of this disclosure may include instructions such that the selected cross-sectional profile is a “Delta” cross section defining three circular vortices of flow, the three circular vortices of flow comprising a main vortex of flow and two secondary vortices of flow adjacent to the main vortex of flow on a side closer to an axis of rotation of the impeller.

A method according to various embodiments of the disclosure includes obtaining first information specifying a radius and separation of an upper shroud and lower shroud, and a radius of an inlet section. The method also includes obtaining a first vane path. The method further includes, based on the first information, determining a shape of a baseline impeller, wherein the baseline impeller comprises a sealed shroud having the radius and comprising the upper shroud and the lower shroud, wherein the upper shroud and lower shroud are separated by the separation, and wherein the upper and lower shroud are connected by a virtual vane following the first vane path. The method still further includes defining an internal flow path, wherein the internal flow path comprises a spline centerline connecting a series of section areas disposed along the first vane path. The method includes, for each section area disposed along the spline centerline, connecting the section areas along the spline centerline to define the internal flow path. The method includes extending the internal flow path to meet the inlet section to define a throat way. The method includes defining an inlet pathway extending from the inlet section.

Methods according to various embodiments of the disclosure may include generating instructions for at least one of an additive manufacturing machine or computer numerical control (CND) milling machine to make an impeller comprising the internal flow path, throat way and inlet pathway.

Methods according to various embodiments of this disclosure may include configuring an impeller that is a vane-less centrifugal impeller.

Methods according to various embodiments of this disclosure may include, subsequent to determining the shape of the baseline impeller, dividing the virtual vane into a plurality of sections. The methods may include determining, for each section of the plurality of sections, a cross-section of the impeller along a plane perpendicular to the virtual vane. The methods include selecting a cross-sectional profile. The methods may include, for each section of the plurality of sections, fitting an instance of the selected cross-sectional profile, wherein the cross-sectional profile makes tangential contact with the upper shroud and the lower shroud. The methods may include performing a lofting operation connecting the instances of the selected cross-sectional profile along the spline centerline to define the internal flow path.

In the methods according to various embodiments of this disclosure, the selected cross-sectional profile may have a circular or ovoid shape defining a space for one vortex of flow.

In the methods according to various embodiments of this disclosure, the selected cross-sectional profile may be a “Delta” cross section defining three circular vortices of flow, the three circular vortices of flow comprising a main vortex of flow and two secondary vortices of flow adjacent to the main vortex of flow on a side closer to an axis of rotation of the impeller.

An apparatus according to various embodiments of this disclosure includes an internal flow path, where the internal flow path comprises a spline centerline connecting a series of section areas disposed along a first vane path along which a virtual vane connects an upper shroud and a lower shroud for a sealed shroud of a baseline impeller, the sealed shroud has a shroud radius, the upper shroud and the lower shroud are separated by a defined separation, and each one of the section areas disposed along the spline centerline is connected to adjacent ones of the section areas to define the internal flow path. The apparatus also includes a throat way extending an internal flow path to meet an inlet section, wherein the inlet section has a defined radius. The apparatus may include an inlet pathway extending from the inlet section.

Apparatuses according to various embodiments of this disclosure may form a vane-less centrifugal impeller.

Apparatuses according to various embodiments of this disclosure may include a second instance of the internal flow path, wherein the second instance of the internal flow path may be angularly offset from at least one other instance of the internal flow path. Such apparatuses may include a second instance of the throat way, where the second instance of the throat way may be angularly offset from at least one other instance of the throat way.

In apparatuses according to various embodiments of this disclosure, the virtual vane may be divided into a plurality of sections, each section of the plurality of sections having a cross-section of the impeller along a plane perpendicular to the virtual vane with a cross-sectional profile selected such that the cross-sectional profile makes tangential contact with the upper shroud and the lower shroud. In such apparatuses, instances of the cross-sectional profile may be connected by a lofting operation along the spline centerline to define the internal flow path.

In apparatuses according to various embodiments of this disclosure, the cross-sectional profile may have a circular or ovoid shape defining a space for one vortex of flow.

In apparatuses according to various embodiments of this disclosure, the cross-sectional profile may be a “Delta” cross section defining three circular vortices of flow, the three circular vortices of flow comprising a main vortex of flow and two secondary vortices of flow adjacent to the main vortex of flow on a side closer to an axis of rotation of the impeller.

Although the present disclosure has been described with various embodiments, various changes and modifications may be suggested to one skilled in the art. It is intended that the present disclosure encompasses such changes and modifications as falling within the scope of the claims.

The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

What is claimed is:

1. A non-transitory computer-readable medium containing instructions, which, when executed by at least one processing device of an electronic device, cause the at least one processing device to:
obtain first information specifying a radius and separation of an upper shroud and lower shroud, and a radius of an inlet section;
obtain a first vane path;
based on the first information, determine a shape of a baseline impeller, wherein the baseline impeller comprises a sealed shroud having the radius and comprising the upper shroud and the lower shroud, wherein the upper shroud and lower shroud are separated by the separation, and wherein the upper and lower shroud are connected by a virtual vane following the first vane path;
define an internal flow path, wherein the internal flow path comprises a spline centerline connecting a series of section areas disposed along the first vane path;
for each section area disposed along the spline centerline, connect the section areas along the spline centerline to define the internal flow path;
extend the internal flow path to meet the inlet section to define a throat way; and
define an inlet pathway extending from the inlet section.

2. The non-transitory computer-readable medium of claim 1, further comprising instructions, which, when executed by the processor, cause the apparatus to:
generate instructions for at least one of an additive manufacturing machine or computer numerical control (CNC) milling machine to make an impeller comprising the internal flow path, the throat way, and the inlet pathway.

3. The non-transitory computer-readable medium of claim 2, wherein the impeller is a vane-less centrifugal impeller.

4. The non-transitory computer-readable medium of claim 1, further comprising instructions, which, when executed by a processor, cause the apparatus to:
define a second instance of the internal flow path, wherein the second instance of the internal flow path is angularly offset from at least one other instance of the internal flow path; and
define a second instance of the throat way, wherein the second instance of the throat way is angularly offset from at least one other instance of the throat way.

5. The non-transitory computer-readable medium of claim 2, further comprising instructions, which, when executed by the processor, cause the apparatus to:
subsequent to determining the shape of the baseline impeller, dividing the virtual vane into a plurality of sections;
determine, for each section of the plurality of sections, a cross-section of the impeller along a plane perpendicular to the virtual vane;
select a cross-sectional profile;
for each section of the plurality of section, fit an instance of the selected cross-sectional profile, wherein the cross-sectional profile makes tangential contact with the upper shroud and the lower shroud; and
perform a lofting operation connecting the instances of the selected cross-sectional profile along the spline centerline to define the internal flow path.

6. The non-transitory computer-readable medium of claim 5, wherein the selected cross-sectional profile has a circular or ovoid shape defining a space for one vortex of flow.

7. The non-transitory computer-readable medium of claim 5, wherein the selected cross-sectional profile is a “Delta” cross section defining three circular vortices of flow, the three circular vortices of flow comprising a main vortex of flow and two secondary vortices of flow adjacent to the main vortex of flow on a side closer to an axis of rotation of the impeller.

8. A method, comprising:
obtaining first information specifying a radius and separation of an upper shroud and lower shroud, and a radius of an inlet section;
obtaining a first vane path;
based on the first information, determining a shape of a baseline impeller, wherein the baseline impeller comprises a sealed shroud having the radius and comprising the upper shroud and the lower shroud, wherein the upper shroud and lower shroud are separated by the separation, and wherein the upper and lower shroud are connected by a virtual vane following the first vane path;
defining an internal flow path, wherein the internal flow path comprises a spline centerline connecting a series of section areas disposed along the first vane path;
for each section area disposed along the spline centerline, connecting the section areas along the spline centerline to define the internal flow path;
extending the internal flow path to meet the inlet section to define a throat way; and
defining an inlet pathway extending from the inlet section.

9. The method of claim 8, further comprising:
generating instructions for at least one of an additive manufacturing machine or computer numerical control (CND) milling machine to make an impeller comprising the internal flow path, throat way and inlet pathway.

10. The method of claim 9, wherein the impeller is a vane-less centrifugal impeller.

11. The method of claim 1, further comprising:
defining a second instance of the internal flow path, wherein the second instance of the internal flow path is angularly offset from at least one other instance of the internal flow path; and
defining a second instance of the throat way, wherein the second instance of the throat way is angularly offset from at least one other instance of the throat way.

12. The method of claim 9, further comprising:
subsequent to determining the shape of the baseline impeller, dividing the virtual vane into a plurality of sections;
determining, for each section of the plurality of sections, a cross-section of the impeller along a plane perpendicular to the virtual vane;
selecting a cross-sectional profile;
for each section of the plurality of sections, fitting an instance of the selected cross-sectional profile, wherein the cross-sectional profile makes tangential contact with the upper shroud and the lower shroud; and
performing a lofting operation connecting the instances of the selected cross-sectional profile along the spline centerline to define the internal flow path.

13. The method of claim 12, wherein the selected cross-sectional profile has a circular or ovoid shape defining a space for one vortex of flow.

14. The method of claim 12, wherein the selected cross-sectional profile is a “Delta” cross section defining three circular vortices of flow, the three circular vortices of flow comprising a main vortex of flow and two secondary vortices of flow adjacent to the main vortex of flow on a side closer to an axis of rotation of the impeller.

15. An apparatus, comprising:
an internal flow path, wherein the internal flow path comprises a spline centerline connecting a series of section areas disposed along a first vane path along which a virtual vane connects an upper shroud and a lower shroud for a sealed shroud of a baseline impeller, the sealed shroud having a shroud radius, the upper shroud and the lower shroud separated by a defined separation, each one of the section areas disposed along the spline centerline connected to adjacent ones of the section areas to define the internal flow path;
a throat way extending an internal flow path to meet an inlet section, wherein the inlet section has a defined radius; and
an inlet pathway extending from the inlet section.

16. The apparatus of claim 15, wherein the internal flow path, the throat way, and inlet pathway form a vane-less centrifugal impeller.

17. The apparatus of claim 16, further comprising:
a second instance of the internal flow path, wherein the second instance of the internal flow path is angularly offset from at least one other instance of the internal flow path; and
a second instance of the throat way, wherein the second instance of the throat way is angularly offset from at least one other instance of the throat way.

18. The apparatus of claim 16, wherein the virtual vane is divided into a plurality of sections, each section of the plurality of sections having a cross-section of the impeller along a plane perpendicular to the virtual vane with a cross-sectional profile selected such that the cross-sectional profile makes tangential contact with the upper shroud and the lower shroud, and
wherein instances of the cross-sectional profile are connected by a lofting operation along the spline centerline to define the internal flow path.

19. The apparatus of claim 18, wherein the cross-sectional profile has a circular or ovoid shape defining a space for one vortex of flow.

20. The apparatus of claim 18, wherein the cross-sectional profile is a “Delta” cross section defining three circular vortices of flow, the three circular vortices of flow comprising a main vortex of flow and two secondary vortices of flow adjacent to the main vortex of flow on a side closer to an axis of rotation of the impeller.
